(19) United States
(12) Patent Application Publication
(10) Pub. No.: US 2015/0235135 A1
(43) Pub. Date: Aug. 20, 2015

(54) CREATING EPISODIC MEMORY BASED ON UNSTRUCTURED DATA IN ELECTRONIC DEVICES

(71) Applicant: Samsung Electronics Co., Ltd., Suwon-si (KR)

(72) Inventors: Lokendra SHASTRI, Kensington, CA (US); Rohini NOOKALA, Andhra Pradesh (IN); Sohini SENGUPTA, Bangalore (IN); Kapil KHATKE, Bangalore (IN); Kailash ATAL, Bangalore (IN); Nishu BANSAL, Ludhiana (IN); Rajat TANDON, Uttar Pradesh (IN); Udaya KUMAR, Bangalore (IN)

(21) Appl. No.: 14/626,144

(22) Filed: Feb. 19, 2015

(30) Foreign Application Priority Data
Feb. 20, 2014 (IN) 817/CHE/2014

(51) Int. Cl. G06N 5/04; G06F 17/30

(52) U.S. Cl. CPC G06N 5/04; G06F 17/3061

(57) ABSTRACT

A method and system for identifying episodic events in a user's life using an electronic device are provided. The method includes receiving, by the electronic device, unstructured data from at least one data source associated with a user, and identifying at least one episodic event from the unstructured data based on at least one parameter, wherein the at least one parameter is at least one of a casual reasoning, a spatial reasoning, or a temporal reasoning.

### CROSS-REFERENCE TO RELATED APPLICATION(S)

This application claims the benefit under 35 U.S.C. §119(a) of an Indian Provisional patent application filed on Feb. 20, 2014 in the Indian Intellectual Property Office and assigned Serial number 817/CHE/2014, and of an Indian Non-Provisional patent application filed on Nov. 13, 2014 in the Indian Intellectual Property Office and assigned Serial number 817/CHE/2014, the entire disclosure of each of which is hereby incorporated by reference.

### TECHNICAL FIELD

The present disclosure relates to Personal Assistants, Smart Assistants, and Content management systems. More particularly, the present disclosure relates to a method and system for constructing episodic memories of a user by extracting episodic elements from unstructured data about a user received from the user, or from another source.

### BACKGROUND

Episodic memory refers to a richly indexed, spatio-temporally structured memory of particular and specific events and situations in a person's life. Content management systems allow a user to retrieve digital content by specifying time and location, album names, and semantic tags. However, people often recall and communicate about the past in terms of their episodic memories rather than in terms of absolute dates and times. In order to provide a user with a more natural experience, a system and a method must allow the user to specify the digital content the user wants to retrieve in terms of events and situations in the user's episodic memory.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system for constructing episodic memories of a user by extracting episodic elements from unstructured data about a user received from the user, or from another source

A principal aspect of the various embodiments herein is to provide a method and system for identifying episodic events associated with a user's life in user's memory using unstructured data about the user.

Another aspect of the various embodiments herein is to extract episodic facts in the user's life by using a Natural Language Processing (NLP) engine and Temporal-Spatial Reasoning.

Another aspect of the various embodiments herein is to retrieve content stored as an episodic event in an electronic device.

Another aspect of the present disclosure is to provide a method of identifying episodic events using an electronic device. The method includes receiving, by the electronic device, unstructured data from at least one data source associated with a user and identifying at least one episodic event from the unstructured data based on at least one parameter, wherein the at least one parameter is at least one of a casual reasoning, a spatial reasoning and a temporal reasoning.

Another aspect of the present disclosure is to provide an electronic device. The electronic device includes a data source configured to include data associated with a user, and a controller module configured to receive unstructured data from the data source and to identify at least one episodic event from the unstructured data based on at least one parameter, wherein the at least one parameter is at least one of a casual reasoning, a spatial reasoning and a temporal reasoning.

Another aspect of the present disclosure is to provide a non-transitory computer readable recording medium having a computer program recorded thereon. The computer program causes a computer to execute a method including receiving unstructured data from at least one data source associated with the user and identifying at least one episodic event from the unstructured data based on at least one parameter, wherein the at least one parameter is at least one of a casual reasoning, a spatial reasoning and a temporal reasoning.

Another aspect of the present disclosure is to provide a method of displaying contents in an electronic device. The method includes acquiring a voice input, identifying an episodic event from the voice input, acquiring at least one episodic element related to the episodic event from the voice input, retrieving at least one content corresponding to the at least one acquired episodic element from a storage, and displaying a visual object indicating the retrieved at least one content.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a high level overview of a system for creating an episodic memory in an electronic device according to an embodiment of the present disclosure;

FIG. 2 illustrates modules of an electronic device used for identifying episodic events according to an embodiment of the present disclosure;

FIG. 3 is an example illustration of unstructured data sources received as input to an Natural Language Processing (NLP) engine according to an embodiment of the present disclosure;

FIG. 4 is a flow diagram illustrating a method of identifying episodic events using an electronic device according to an embodiment of the present disclosure;

FIG. 5 is a flow diagram illustrating a method of retrieving an episodic event according to an embodiment of the present disclosure;

FIGS. 6A and 6B are example illustrations of user interactions with an electronic device to identify an episodic event and episodic memories of a user's life according to various embodiment of the present disclosure;

FIG. 7 is an example illustration of a plurality of episodic elements and a plurality of events stored in an episodic memory management module according to an embodiment of the present disclosure;

FIG. 8 is an example illustration of a method of retrieving content from an electronic device according to an embodiment of the present disclosure; and

FIG. 9 depicts a computing environment implementing a system and method(s) of identifying episodic events, identifying episodic relations, and creating and storing episodic memories of a user in an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The various embodiments disclosed here provide a method of identifying episodic events using an electronic device. The method includes using unstructured data associated with a user from data sources and identifying at least one episodic event representing user's memory from the unstructured data based on at least one parameter, wherein said parameter is at least one of a spatial reasoning and a temporal reasoning.

The method and system described herein is simple and robust for creating an episodic memory representing a user's autobiographical episodic events (times, places, associated emotions, names, and other contextual information related to who, what, when, where, why knowledge) that can be explicitly stated. Unlike systems of the related art, the proposed system and method can be used to identify the episodic events of the user using unstructured data. For example, the unstructured data can be narrated by the user or extracted from various data sources associated with the user. The method and system can be used by a smart assistant to understand references to a past memory (i.e., episodic event) made by the user and to help the users to provide assistance in quickly remembering and recalling the user past personal experiences that occurred at a particular time and place.

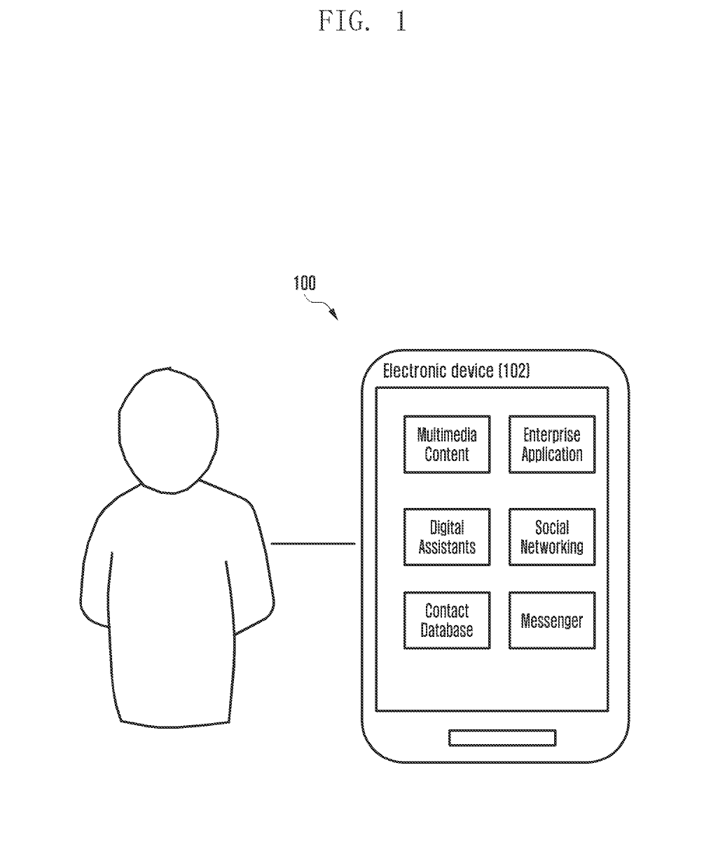

FIGS. 1 through 9, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 illustrates a high level overview of a system for creating an episodic memory in an electronic device according to an embodiment of the present disclosure.

Referring to FIG. 1, a system 100 is illustrated, where the system 100 includes an electronic device 102 with several applications commonly used by a user. Electronic devices, such as the electronic device 102, are becoming indispensable personal assistants in people's daily life as these devices support work, study, play and socializing activities. A plurality of multi-modal sensors and rich features of the electronic devices can capture abundant information about users' life experience, such as taking photos or videos on what they see and hear, and organizing their tasks and activities using applications like calendar, to-do list, notes, and the like.

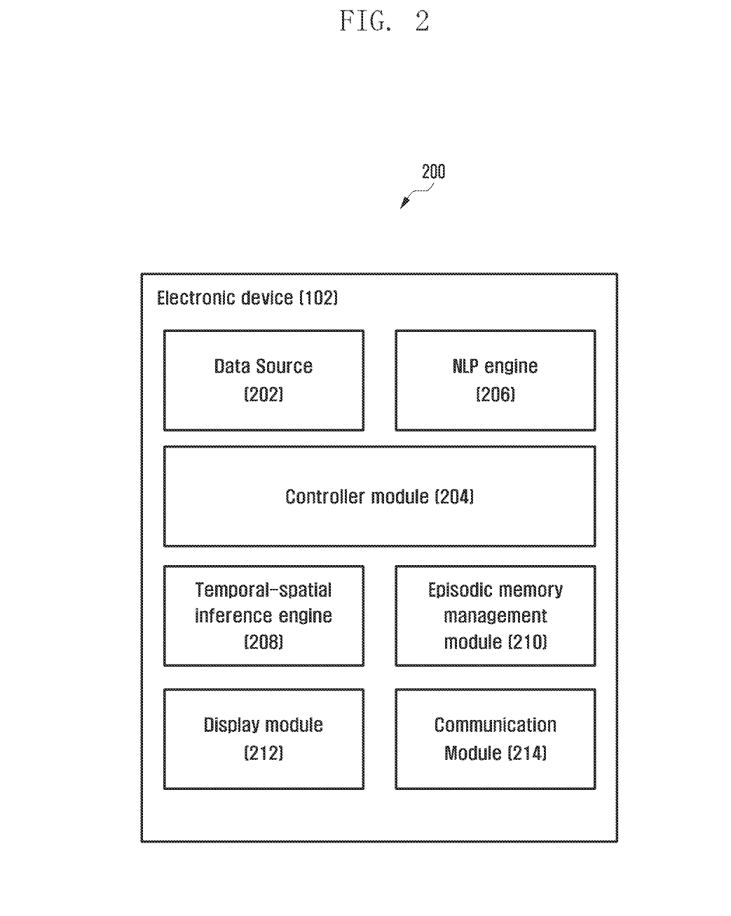

Specifically, as the electronic device 102 contains a lot of personal information about the user, they start acting as the user's alter ego (a user's second self or a trusted friend). As the user recalls memories in terms of events and situations in their lives, the electronic device 102 can be configured to identify episodic events and stored episodic memories. The availability of personal information allows the user to recall memories and remember past experiences. To recall memories and remember past experiences, the electronic device 100 can be configured to identify, store and retrieve episodic events and memories by way of multimedia content, digital assistants, a contact database, an enterprise application, social networking and a messenger. A method of identifying, creating, storing and retrieving episodic events in the user's life through the electronic device 102 is explained in conjunction with FIGS. 2-5.

FIG. 2 illustrates various modules of an electronic device used for identifying episodic events according to an embodiment of the present disclosure.

Referring to FIG. 2, an electronic device 102 is illustrated, where the electronic device 102 can be configured to include a data source 202, a controller module 204, a Natural Language Processing (NLP) engine 206, a temporal-spatial inference engine 208, an episodic memory management module 210, a display module 212, and a communication module 214.

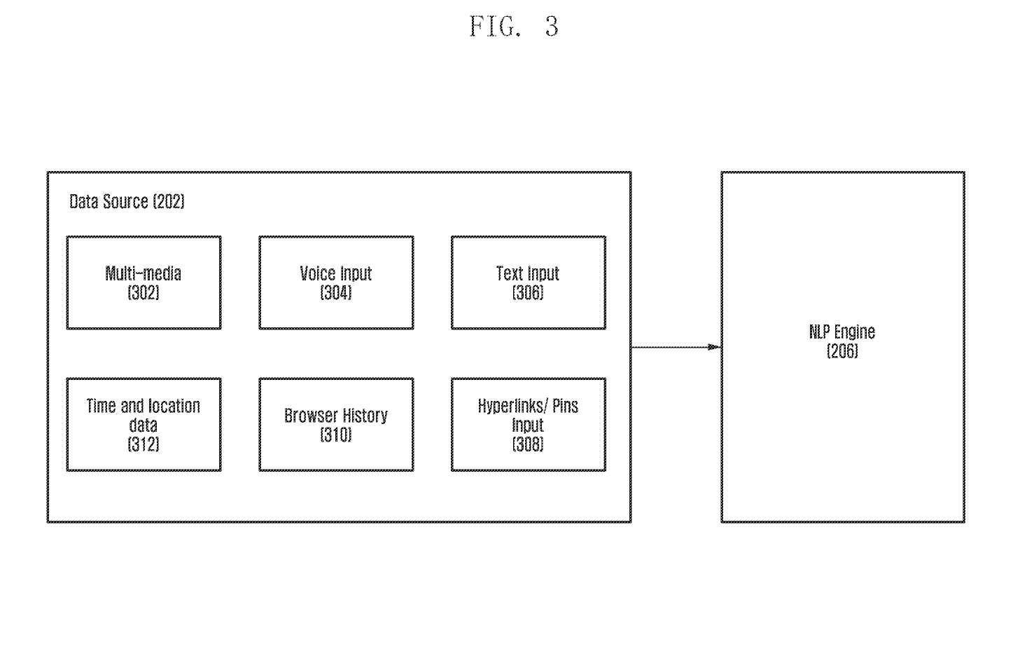

The data source 202 can be configured to include a plurality of data associated with the user of the electronic device 102. The data can include unstructured data and structured data. Examples of data sources in the electronic device 102 used for language processing and temporal-spatial reasoning can include for example, but is not limited to, a plurality of Short Messaging Services (SMS's), a plurality of emails, a plurality of calendar entries, a voice recording of the user, metadata associated with content, and extracted episodic elements during communication session. The various data sources providing unstructured data associated with the user of the electronic device 102 are explained in conjunction with FIG. 3. The data sources 202 are used by the NLP engine 206 to extract episodic elements from the unstructured data.

The controller module 204, in communication with a plurality of modules including the temporal-spatial inference engine 208 and the NLP engine 206, can be configured to identify the episodic events in the unstructured data representing past personal experiences that occurred at a particular time and place.

The controller module 204 in the electronic device 102 can be configured to identify at least one episodic event from the unstructured data based on at least one parameter. The parameter described herein can include, but is not limited to, a casual reasoning, a spatial reasoning and a temporal reasoning. The spatial and temporal reasoning is performed to infer missing or implicit information about a time, a location and a description related to an episodic event.

The controller module 204 in the electronic device 102 can be configured to extract episodic elements associated with the identified episodic event using the NLP engine 206. The NLP engine 206 includes tools related to speech recognition, speech syntheses, Natural Language Understanding (NLU), and the like to extract the episodic elements. In an embodiment, the controller module 204 can be configured to structure the extracted episodic elements into identifiable episodic events using contextual information, and causal and referential inferences.

In an embodiment, the controller module 204 can be configured to use the temporal-spatial inference engine 208 to infer missing or implicit data from the unstructured data and the extracted elements in a given text/dialog/user utterance. The temporal-spatial inference engine 208 uses abstractions of temporal and spatial aspects of common-sense knowledge to infer implicit and missing information. The spatial and temporal inference engine 208 can also use the extracted episodic elements from the various data sources, such as the data source 202, to infer missing or implicit information about the time, the location and description associated with an episodic event.

In an embodiment, the temporal-spatial inference engine 208 can infer information about the user's life by using features like intelligent dynamic filtering, context sensitive situation awareness, an intelligent watch, dynamic discovery and delivery, ontology data mapping and the like.

In an embodiment, the controller module 204 can be configured to identify at least one episodic relation between the identified episodic events and existing episodic events using the temporal-spatial inference engine 208. The episodic events described herein can include for example, but not limited to, during, before, after, at the same place, with the same person, and the like. The episodic events may also trigger the learning of semantic information—that is new categories, new correlations and new causal models. For example, being mugged multiple times at night in different location may induce a fear of walking alone in the night as a result of episodic learning.

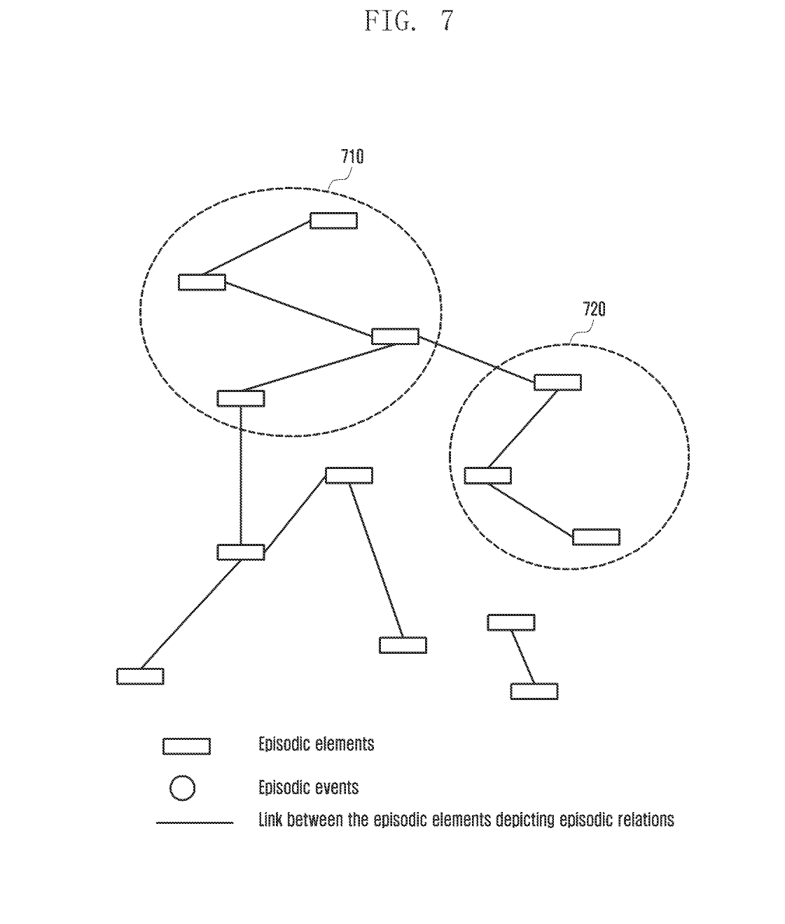

The episodic memory management module 210 can be configured to store the extracted episodic elements, the identified episodic events, the identified episodic relations about the user in an episodic memory structure. An example of the stored episodic memory structure in the episodic memory management module 210 is explained in conjunction with FIG. 7.

Consider an example of a graduation which is followed by a party with friends. The graduation and the party can form an episodic relation.

In an embodiment, the episodic relations can be identified by the controller module 204 based on the timestamps associated with each event, events which follow one another, events occurring at the same time, events which have common people, and the like.

Further, the display module 212 can be configured to display a retrieved episodic event based on the user query. Based on the query given by the user of the electronic device 102, the controller module 204 can be configured to retrieve the content associated with the episodic event and display on the screen of the electronic device 102. The communication module 214 can be configured to share the episodic events in the electronic device 102 with other users based on instructions from the user of the electronic device 102.

The identification of episodic events and the creation of episodic memories can be easily implemented in smart electronic devices, smart homes, and smart cars which are aware of the current context and the key events and situations in the user's life.

FIG. 2 illustrates a limited overview of various modules of the electronic device 102 but, it is to be understood that other various embodiments are not limited thereto. The labels or names of the modules are used only for the illustrative purpose and does not limit the scope of the present disclosure. Further, in real-time the function of the one or more modules can be combined or separately executed by the same or other modules without departing from the scope of the present disclosure. Further, the electronic device 102 can include various other modules along with other hardware or software components, communicating locally or remotely to identify and create the episodic memory of the user. For example, the component can be, but not limited to, a process running in the controller or processor, an object, an executable process, a thread of execution, a program, or a computer. By way of illustration, both an application running on an electronic device and the electronic device itself can be a component.

FIG. 3 is an example illustration of unstructured data sources received as input to an NLP engine according to an embodiment of the present disclosure.

Referring to FIG. 3, an NLP engine 206 and a data source 202 are illustrated, where the NLP engine 206 can be configured to receive data from multiple data sources, including the data source 202. The data source 202 may include multi-media 302 present in the electronic device 102. Semantic data, such as a date and a location associated with the multi-media content 302 can be used as an unstructured data input to the NLP engine 206.

A voice input 304 can be used by the NLP engine 206 to extract episodic elements associated with episodic events. The voice input 304 can include data like voice recording, voice inputs provided to the electronic device 102 through a microphone, voice calls performed using a communication module included in the electronic device 102, and so on. The NLP engine 206 can be used for extracting episodic elements associated with at least one episodic event from the voice input.

The extracted episodic elements can be used by the temporal-spatial inference engine 208, as illustrated in FIG. 2, to infer data missing in the identified episodic events. For example, from a voice call in the electronic device 102 of FIG. 1, the NLP engine 206 can extract the episodic elements like college, hockey, party, state championship, and the like. The temporal-spatial inference engine 208 can associate the extracted episodic elements with content present in the electronic device 102. For example, the episodic elements extracted using the NLP engine 206 can be associated with a photo album, which was created during a university period (the years in which the user was in a university) of the user's life. The episodic event gets identified and tagged to the photos present in the electronic device 102. The identified episodic event allows users to access the photo album by simple voice input like “Show me the pictures of the state championship”. The controller module 204 can access the episodic memory management module 210 to display photos tagged to an episodic event (e.g., the state championship).

A text input 306 associated with the user may include, for example, but not limited to, SMS, documents, emails, comments provided by the user, blogs written by the user, and the like and can act as the data source 202 to the NLP engine 206. The NLP engine 206 can use time and location data 312 from applications present in the electronic device 102 to identify episodic events. For example, when the user of the electronic device 102 uses a map application to go to a concert in a town, the NLP engine 206 can utilize this information (i.e. information acquired according to the using of the map application) to extract episodic elements like date, concert, and location for identifying the episodic event.

Inputs like browser history 310, hyperlinks/pins 308 and the like created by the user of the electronic device 102 can act as input for extracting the episodic elements associated with the user.

The extraction of the episodic elements associated with the user through multiple data sources, such as the data source 202, constantly allows the electronic device 102 to identify the episodic events occurring in the user's life without receiving any explicit information from the user.

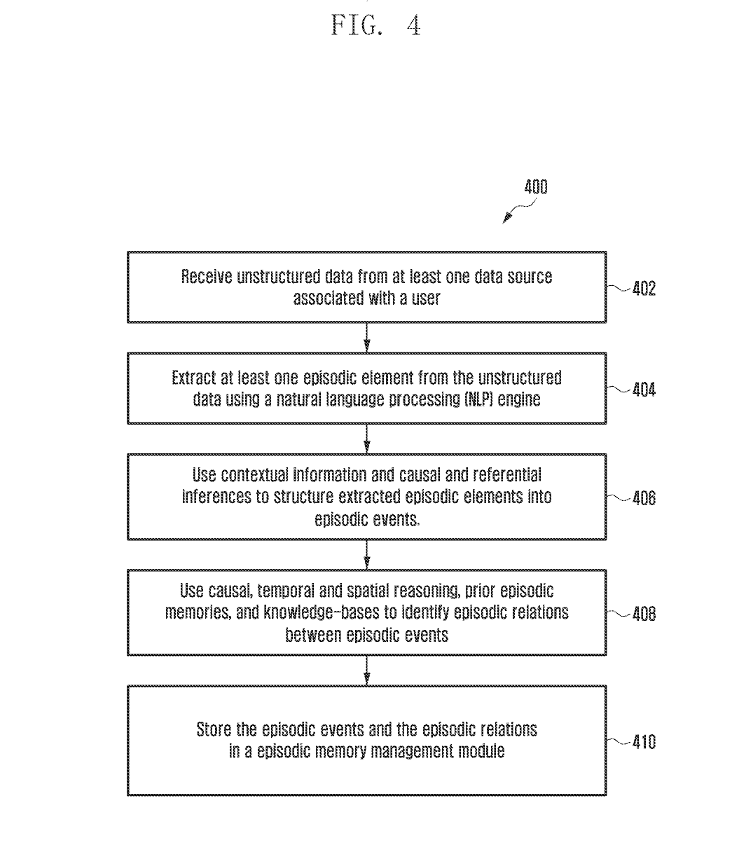

FIG. 4 is a flow diagram illustrating a method of identifying episodic events using an electronic device according to an embodiment of the present disclosure.

Various operations of the method are summarized into individual blocks where some of the operations are performed by the electronic device 102 as illustrated in FIG. 1, a user of the electronic device 102, and a combination thereof. The method and other description described herein provide a basis for a control program, which can be implemented using a microcontroller, a microprocessor or a computer readable storage medium.

Referring to FIG. 4, a method 400 is illustrated, where the method includes, at operation 402, receiving unstructured data from at least one data source associated with a user of the electronic device 102. The electronic device 102 may include the user's personal data like contacts, documents, browser preferences, bookmarks, media content but may not be aware of the episodic events associated with the users past or episodic events associated with the data present in the electronic device 102, for example, when the user interacts with the electronic device 102 for the first time.

To solve this problem, the controller module 204, as illustrated in FIG. 2, can be configured to request the user to provide a short narrative about key events in the user's life. The user can provide the information to the electronic device 102 using any of a number of available input and output mechanisms in the electronic device 102, such as for example speech, graphical user interfaces (buttons and links), text entry, and the like. In an embodiment, the content present in the episodic memory management module 210, as illustrated in FIG. 2, can be stored in an alternative source. For example, the user's episodic memories can be stored in cloud storage. If the user loses his electronic device 102, the episodic memories, which are stored in the alternative source, can transferred to other electronic device instead of re-creating the user's episodic memory.

At operation 404, the method 400 includes extracting at least one episodic element from the unstructured data using the NLP engine 206, as illustrated in FIG. 2. In an embodiment, when the user interacts with the electronic device 102 for the first time, the NLP engine 206 can be used for extracting the episodic elements from the user's narrative. For example, a voice based narrative provided by the user can be processed by the electronic device using, tools related to the speech recognition, speech synthesis and the NLU available in the NLP engine 206.

In an embodiment, the user of the electronic device 102 may be requested to provide information about an existing digital content. For example, when a new photo album is added to the photo library, the controller module 204 can request the user to provide information about the digital content. A message (e.g., a visual message or an audio message) may be output from the electronic device 102 for requesting the user to provide information related to the digital content. The information provided by the user may be added as Meta data to the digital content.

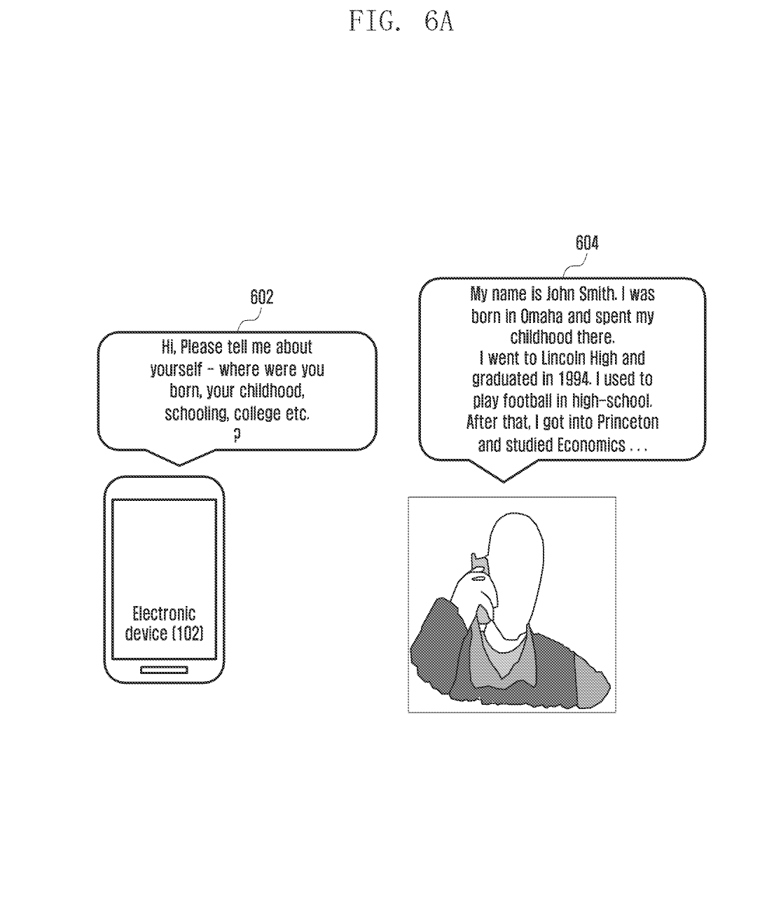

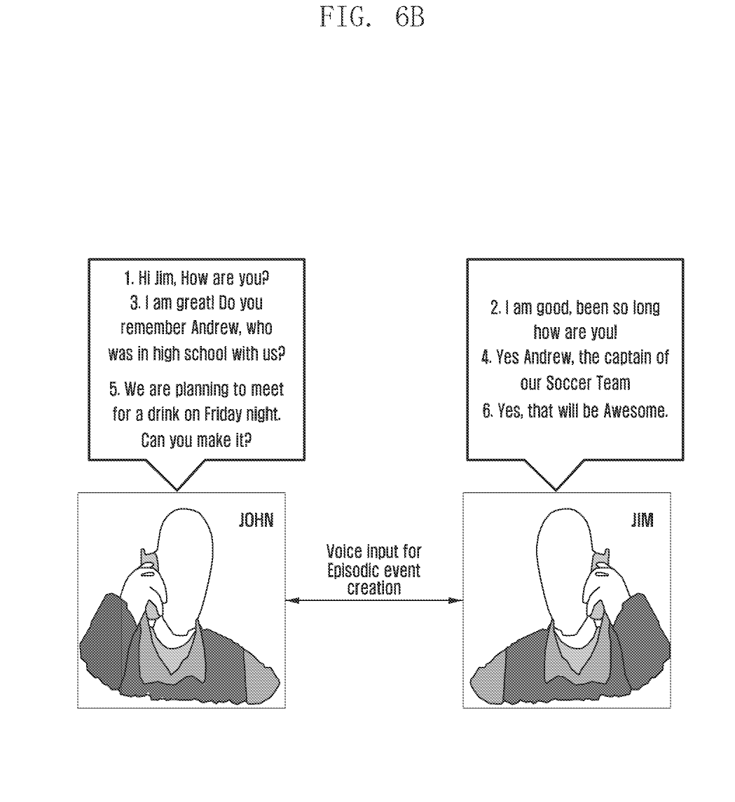

At operation 406, the method 400 includes using contextual information, a plurality of causal and referential inferences to structure extracted episodic elements into identifiable episodic events. Each episodic element can be inferred from the contextual information and the plurality of causal and referential inferences to identify episodic events. In an embodiment, to identify the episodic events occurring in the user's past; the method 400 allows the controller module 204 to use parameters like the spatial reasoning and temporal reasoning. The temporal-spatial inference engine 208, as illustrated in FIG. 2, can add semantic data like location and time of extracted episodic events. In an embodiment, based on the available episodic elements in the episodic memory management module 210, as illustrated in FIG. 2, and the extracted episodic elements, the method 400 allows the temporal-spatial inference engine 208 to infer missing or implicit information about the time and place of the extracted episodic elements. In an embodiment, the temporal-spatial inference engine 208 can be configured to infer episodic elements associated with at least one event. For example, when the user in a voice call talks about going for a 10^{th} year high school reunion the next month, the temporal-spatial inference engine 208 can infer an episodic element that the year in which the user graduated from high school was 10 years ago. The temporal-spatial inference engine 208 can use stored episodic events, the episodic elements generated from various events, the data sources, such as the data source 202 as illustrated in FIG. 2, on the electronic device 102 to infer implicit information. An example of temporal and spatial reasoning of an unstructured data is described in conjunction with FIGS. 6A and 6B.

At operation 408, the method 400 includes identifying, by using causal, temporal and spatial reasoning, prior episodic memories and knowledge-bases, at least one episodic relation between the identified at least one episodic event and at least one episodic event stored in the electronic device. In an embodiment, the temporal-spatial inference engine 208 can link the episodic memory of one user with episodic memory of another user, when the user shares the episodic events. The temporal-spatial inference engine 208 can infer that the episodic events of both the users have some common links.

The method 400 allows the controller module 204 to identify at least one episodic relation and construct an episodic memory using the extracted episodic elements, the inferred episodic elements, the identified episodic events and the identified episodic relations. In an embodiment, the method 400 allows the controller module 204 to identify episodic relations between different episodic events.

At operation 410, the method 400 includes storing the identified episodic events, and the identified episodic relations in the episodic memory management module 210, as illustrated in FIG. 2, which provides access and update methods to access and update the contents of episodic memory (e.g., episodic elements, events and relations). Each episodic event is associated with at least one of a time, a location, and a description. Each of the identified episodic events is related to one other via the episodic relations and stored in the episodic memory management module 210. The episodic elements, episodic events and the episodic relations are linked with each other and stored in the episodic memory management module 210. An example representation of the episodic event and the episodic elements is described in conjunction with FIG. 7.

Further, the method and system shares a user's experiential memory, and hence, with whom the user can interact in a natural manner by referring to events and situations in their life. Further, the method and system enable the users to retrieve digital content using references to events and situations in their daily life without requiring them to specify specific dates, locations, album names, pre-determined tags, and sources.

The various actions, acts, blocks, steps, operations, and the like in the method 400 may be performed in the order presented, in a different order or simultaneously. Further, in some embodiments, some actions, acts, blocks, steps, operations, and the like may be omitted, added, modified, skipped, and the like without departing from the scope of the present disclosure.

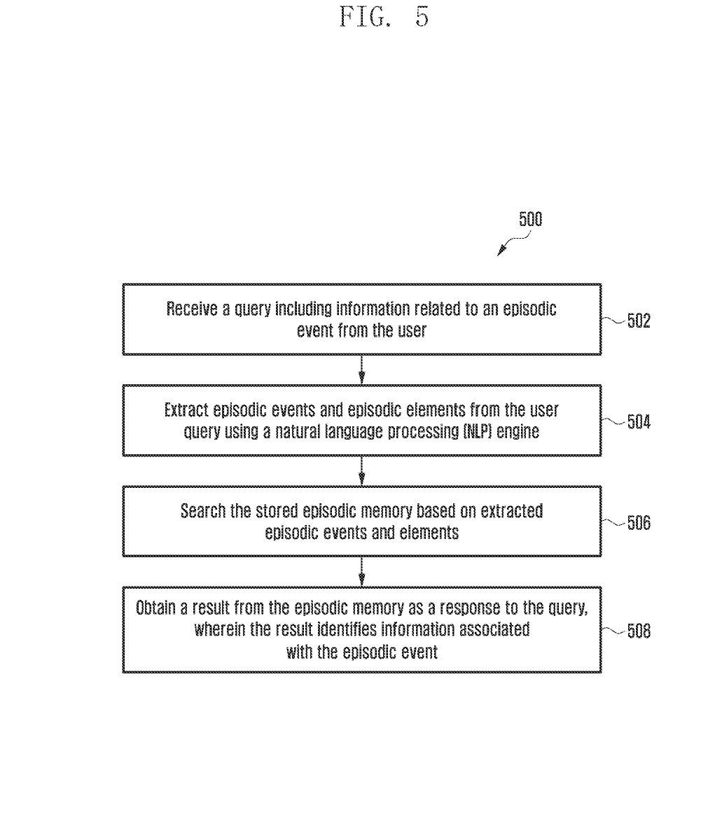

FIG. 5 is a flow diagram illustrating a method of retrieving an episodic event according to an embodiment of the present disclosure.

Various operations of the method are summarized into individual blocks where some of the operations are performed by the electronic device 102 as illustrated in FIG. 1, the user of the electronic device 102, and a combination thereof. The method and other descriptions described herein provide a basis for a control program, which can be implemented using a microcontroller, microprocessor or any other computer readable storage medium. In an embodiment, the user can verbally instruct the electronic device 102 to retrieve content by providing references to events and situation in the user's life (episodic memories of the user's life).

Referring to FIG. 5, a method 500 is illustrated, where the method 500 includes, at operation 502, receiving a query including information related to an episodic event from the user of the electronic device 102. The query described herein can include information such as for example, but not limited to, photos, songs, contacts, other information as desired by the user. The query can be received through available input and output mechanisms, such as for example speech, graphical user interfaces (buttons and links), text entry, and the like.

At operation 504, the method 500 includes extracting episodic events and episodic elements from the user query using the NLP engine 206, as illustrated in FIG. 2. The received query is analyzed by the NLP engine 206 to extract episodic elements and identify the episodic events to be searched. In case of a voice input, the NLP engine 206 can extract the elements in the query.

At operation 506, the method 500 includes searching the episodic memory stored in the episodic memory management module 210, as illustrated in FIG. 2, based on the extracted episodic elements and the episodic events. The user's episodic memory stored in the episodic memory management module 210 can be used for inferring the query given by the user. Based on the episodic elements, and episodic events extracted from the query, the controller module 204, as illustrated in FIG. 2, searches the episodic memory (including episodic elements, episodic events and the episodic relations) in the episodic memory management module 210 to identify the episodic elements and the episodic event associated with the query. An electronic memory structure (as shown in FIG. 7) and existing search and access algorithms can be used by the episodic memory management module 210 to find the results for the received query.

At operation 508, the method 500 includes obtaining a result from the episodic memory management module 210 as a response to the query. The user episodic memory can be used to infer the result in response to the query. The inferred result identifies information associated with the episodic event. Based on the identified episodic elements and episodic events, a result can be displayed to the user of the electronic device 102. The results include information requested by the user in the query. The result can include, but is not limited to, images, documents, chat histories, emails, messages, audio, and video and so on.

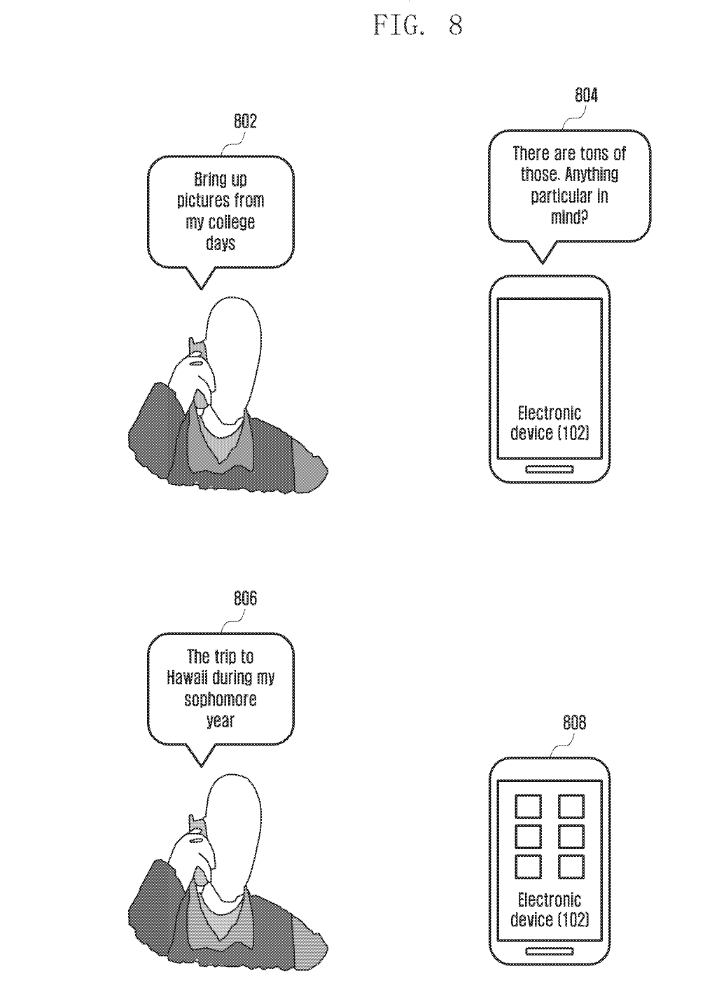

In an embodiment, when there are multiple results identified by the controller module 204 (e.g., a number of the results exceeds a preset value), the method 500 allows the controller module 204 to initiate a dialogue with the user to obtain more specific elements from the query. An example illustration depicting a process of retrieving content using the episodic memory management module 210 is described in conjunction with FIG. 8.

The various actions, acts, blocks, steps, operations, and the like in the method 500 may be performed in the order presented, in a different order or simultaneously. Further, in some embodiments, some actions, acts, blocks, steps, operations, and the like may be omitted, added, modified, skipped, and the like without departing from the scope of the present disclosure.

FIGS. 6A and 6B are example illustrations of user interactions with an electronic device to identify an episodic event and episodic memories of a user's life according to an embodiment of the present disclosure.

Referring to FIG. 6A, a narrative 602 output by the electronic device 102 is: “Hi, Please tell me about yourself—where were you born, your childhood, schooling, college etc.?” and a narrative 604 received by the electronic device 102 is: “My name is John Smith. I was born in Omaha Nebr. and spent my childhood there. I went to Lincoln High and graduated in 1994. I used to play football in high-school. After that I got into Princeton and studied Economics”.

The controller module 204, as illustrated in FIG. 2, may extract the episodic elements using the NLP engine 206, as illustrated in FIG. 2, and the temporal-spatial inference engine 208, as illustrated in FIG. 2, about the episodic events associated with the narrative provided by the user of the electronic device 102. From the sample narrative received from the user, the controller module 204 may extract the year of the user's birth, that is, John Smith was born in Omaha during (1975-1977), which may be inferred using temporal reasoning based on the year of graduation from high-school. Further, the controller module 204 may extract the living space and period of the user, that is, John Smith has lived in Omaha during (1975-1994), which may be inferred using temporal reasoning based on the year of graduation from high-school. Furthermore, the controller module 204 may extract that John Smith has attended school (LincolnHigh543, during (1990-1994)) which may be inferred using temporal reasoning. In a similar way as described above, the controller module 204 may extract all the episodic elements of the user based on the unstructured narrative received from the user which may be inferred using temporal reasoning.

The episodic facts extracted by the NLP engine 206 and the temporal-spatial inference engine 208 about John Smith are given in the Table 1 below:

TABLE 1

| Episodic elements extracted | Inferred using |
|---|---|
| Born(Omaha, during(1975-1977)) | temporal reasoning |
| Lived-in(Omaha, during(1975-1994)) | temporal reasoning |
| Attended-School(LincolnHigh543, during(1990- | temporal reasoning |
| 1994)) | |
| Played (Football, during(1990-1994) | temporal reasoning |
| Injured(Shoulder, during(1990-1994)) | temporal reasoning |
| Attended-College(Princeton, during(1994-1998)) | temporal reasoning |
| College-Major(Economics) | |

Referring to FIG. 6B, a conversation between two users which can be used for identifying episodic events associated with the user's life is illustrated. This episodic event may be a common episodic event between the two users. Based on the conversation between the two user's, the episodic elements like Andrew, high school, drinks, Friday night can be identified by the NLP engine 206, as illustrated in FIG. 2. The temporal-spatial inference engine 208, as illustrated in FIG. 2, can infer other additional episodic elements like Andrew was in high school with both the users, and both the users in the conversation were part of the soccer team.

In an embodiment, the user can provide the information to the electronic device 102, as illustrated in FIG. 2, about content which is being viewed by the user. For example, the user may wish to create videos depicting different stages in the life of his child. For each video, the user may provide a narrative description which can be used for extracting the episodic elements and the episodic event.

The various embodiments described, allows the user to shares his experiential memory. The user can recall and share these memories by interacting in a natural manner with the electronic device 102 by referring to events and situations in their life.

For example, as illustrated in FIG. 6B, a user John may ask a user Jim “Hi Jim, How are you?” and the user Jim may respond “I am good, been so long how are you!” Further, John may respond “I am great! Do you remember Andrew, who was in high school with us?” and Jim may respond “Yes Andrew, the captain of our Soccer Team.” Moreover, John may respond “We are planning to meet for a drink on Friday night. Can you make it?” and Jim may respond “Yes, that will be Awesome.”

FIG. 7 is an example illustration of a plurality of episodic elements and a plurality of events stored in an episodic memory management module according to an embodiment of the present disclosure.

Referring to FIG. 7 a plurality of episodic elements linked to each other in a map like structure are illustrated. Such a structure organizes the episodic events in terms of temporal relations such as before, after, and during. The episodic elements extracted from the data sources are linked to each other based on episodic relations between the episodic elements and stored in the episodic memory management module 210, as illustrated in FIG. 2.

Each link represents the relationship between the episodic elements and the episodic events in the episodic memory structure. The structure also organizes the episodic events according to event types, event participants, event locations, and event themes. Based on the extracted episodic elements and the inference from the temporal-spatial inference engine 208, as illustrated in FIG. 2, the controller module 204, as illustrated in FIG. 2, can be configured to identify the episodic events and the episodic relations in the user's life. Circles 710 and 720 in FIG. 7 illustrate the episodic events identified by the controller module 204.

Consider an example of a picnic event where a group of friends went together after the completion of an important project. During the picnic event in user's memory, Mr. Jim had a bad accident which led to hospitalization. Mr. Jim, the names of other friends, the project completed can act as episodic elements of the picnic event. The event related to Mr. Jim's accident is episodically related to the picnic event as both the events occurred at the same time. Hence an episodic relation can be formed between the accident event and the picnic event. An element related to the accident can be present in the picnic event. The accident in user's memory may be stored as event of its own including elements like visits by friends at hospital, the progress of physiotherapy, the surgery details, and so on.

FIG. 8 is an example illustration of a method of retrieving content from the electronic device according to an embodiment of the present disclosure.

Referring to FIG. 8 a dialog between a user and an electronic device 102 for retrieving the content requested by the user is illustrated. At 802, the electronic device 102 receives a voice query through a microphone from the user requesting pictures of his college days. At 804, the electronic device 102 obtains multiple results based on the users query and outputs a voice, to a speaker, for requesting the user for more specific information.

At 806, when the user responds “The trip to Hawaii during my sophomore year,” the controller module 204 can identify the trip as the episodic event. At 808, contents (e.g., pictures) tagged with the episodic elements of the trip (Hawaii, college (location), sophomore year (date)) are retrieved from a storage of the electronic device 102 and displayed on the screen of the electronic device 102. Alternatively, visual objects (e.g., thumbnails or icons) corresponding to the retrieved contents may be displayed on the screen.

The various embodiments described here allow the users of the electronic device 102 to retrieve content using references to events and situations in their daily life without requiring them to specify specific dates, locations, album names, pre-determined tags, and sources.

The electronic device 102 with episodic memory identification and episodic memories can be used by Generation-X (Gen-X) users as the electronic device 102 is an essential part in the life of the Gen-X. Baby-boomers can also use electronic device 102 with episodic memory identification and episodic memories as it offers a form of “assisted cognition” since there is no need for the user to remember specific dates and locations.

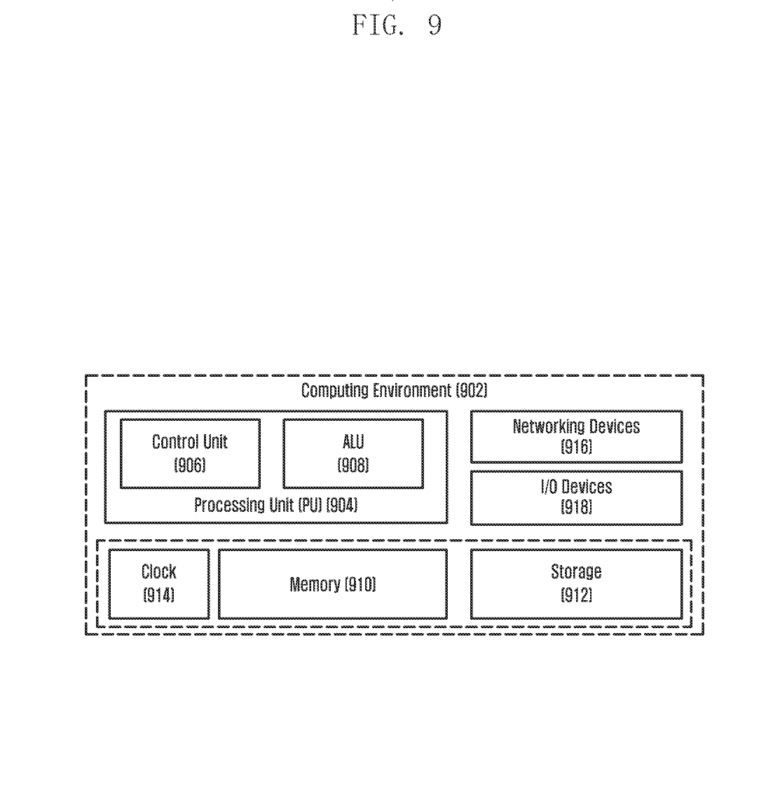

FIG. 9 depicts a computing environment implementing a system and method(s) of identifying episodic events, identifying episodic relations, and creating and storing episodic memories of a user in an electronic device according to an embodiment of the present disclosure.

Referring to FIG. 9, a computing environment 902 is illustrated, where the computing environment 902 may include at least one processing unit 904 that is equipped with a control unit 906 and an Arithmetic Logic Unit (ALU) 908, a memory 910 a storage (unit) 912, a clock (chip) 914, networking devices 916, and Input/output (I/O) devices 918. The processing unit 904 is responsible for processing the instructions of the algorithm. The processing unit 904 receives commands from the control unit 906 in order to perform its processing. Further, any logical and arithmetic operations involved in the execution of the instructions are computed with the help of the ALU 908.

The overall computing environment 902 can be composed of multiple homogeneous or heterogeneous cores, multiple Central Processing Units (CPUs) of different kinds, special media and other accelerators. The processing unit 904 is responsible for processing the instructions of the algorithm. The processing unit 904 receives commands from the control unit 906 in order to perform its processing. Further, any logical and arithmetic operations involved in the execution of the instructions are computed with the help of the ALU 908. Further, the plurality of process units may be located on a single chip or over multiple chips.

The algorithm comprising of instructions and codes required for the implementation are stored in either the memory unit 910 or the storage 912 or both. At the time of execution, the instructions may be fetched from the corresponding memory 910 or storage 912, and executed by the processing unit 904. The processing unit 904 synchronizes the operations and executes the instructions based on the timing signals generated by the clock chip 914. The various embodiments disclosed herein can be implemented through at least one software program running on at least one hardware device and performing network management functions to control the elements.

The elements shown in FIGS. 2, 3, and 4 include various units, blocks, modules, or operations described in relation with methods, processes, algorithms, or systems of the present disclosure, which can be implemented using any general purpose processor and any combination of programming language, application, and embedded processor.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point, it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood to those skilled in the art that various changes in form and details may be made therein without departing from the spirit and scope of the present disclosure as defined by the appended claims and their equivalents.

What is claimed is:

1. A method of identifying episodic events using an electronic device, the method comprising:
receiving, by the electronic device, unstructured data from at least one data source associated with a user; and
identifying at least one episodic event from the unstructured data based on at least one parameter,
wherein the at least one parameter is at least one of a casual reasoning, a spatial reasoning, or a temporal reasoning.

2. The method of claim 1, wherein the identifying of the at least one episodic event from the unstructured data based on the at least one parameter comprises:
extracting at least one episodic element from the unstructured data using a natural language processing (NLP) engine;
inferring at least one episodic element from the at least one extracted episodic element to identify the at least one episodic event; and
identifying at least one episodic relation between the at least one identified episodic event and at least one episodic event stored in the electronic device using at least one of the casual reasoning, the spatial reasoning, or the temporal reasoning.

3. The method of claim 2, wherein the inferring of the at least one episodic element comprises structuring the extracted at least one episodic element into the at least one episodic event based on contextual information, causal interferences and referential interferences.

4. The method of claim 1, wherein the method further comprises:
receiving a query including information related to an episodic event from the user;
searching an episodic memory management module of the electronic device according to the query; and
obtaining a result from the episodic memory management module as a response to the query,
wherein the result identifies information associated with the episodic event related to the information included in the query.

5. The method of claim 1, wherein the method further comprises sharing the at least one identified episodic event with other users.

6. The method of claim 1,
wherein each identified episodic event of the at least one identified episodic event is combined and stored in an episodic memory management module of the electronic device, and
wherein each independent episodic event of the at least one identified episodic event is associated with at least one of a time, a location, or a description.

7. An electronic device comprising:
a data source configured to include data associated with a user;
a controller module configured to receive unstructured data from the data source, and to identify at least one episodic event from the unstructured data based on at least one parameter; and
an episodic memory management module configured to store the at least one identified episodic event,
wherein the at least one parameter is at least one of a casual reasoning, a spatial reasoning, or a temporal reasoning.

8. The electronic device of claim 7, wherein the controller module is further configured to:
extract at least one episodic element from the unstructured data using a natural language processing (NLP) engine;
infer at least one episodic element from the at least one extracted episodic element to identify the at least one episodic event; and
identify at least one episodic relation between the at least one identified episodic event and at least one episodic event stored in the electronic device using at least one of the casual reasoning, the spatial reasoning, or the temporal reasoning.

9. The electronic device of claim 7, wherein the controller module is further configured to:
receive a query including information related to an episodic event from the user;
search the episodic memory management module according to the query; and
obtain a result from the episodic memory management module as a response to the query,
wherein the result identifies information associated with the episodic event related to the information included in the query.

10. The electronic device of claim 7, wherein the controller module is further configured to share the at least one identified episodic event with other users.

11. The electronic device of claim 7,
wherein each identified episodic event of the at least one identified episodic event is combined and stored in the episodic memory management module,
wherein each identified episodic event of the at least one identified episodic event is associated with at least one of a time, a location, or a description.

12. A non-transitory computer-readable recording medium having a computer program recorded thereon, the computer program causing a computer to execute a method comprising:
receiving unstructured data from at least one data source associated with a user; and
identifying at least one episodic event from the unstructured data based on at least one parameter,
wherein the at least one parameter is at least one of a casual reasoning, a spatial reasoning, or a temporal reasoning.

13. The non-transitory computer-readable recording medium of claim 12, wherein the identifying of the at least one episodic event from the unstructured data based on the at least one parameter comprises:
extracting at least one episodic element from the unstructured data using a Natural Language Processing (NLP) engine;
inferring at least one episodic element from the at least one extracted episodic element to identify the at least one episodic event; and
identifying at least one episodic relation between the at least one identified episodic event and at least one episodic event stored in the electronic device using at least one of the casual reasoning, the spatial reasoning, or the temporal reasoning.

14. The non-transitory computer-readable recording medium of claim 12, wherein the method further comprises:
receiving a query including information related to an episodic event from the user;
searching an episodic memory management module of an electronic device according to the query; and
obtaining a result from the episodic memory management module as a response to the query,
wherein the result identifies information associated with the episodic event related to the information included in the query.

15. The non-transitory computer-readable recording medium of claim 12, wherein the method further comprises sharing the at least one identified episodic event with other users.

16. The non-transitory computer-readable recording medium of claim 12,
wherein each identified episodic event of the at least one identified episodic event is combined and stored in an episodic memory management module, and
wherein each identified episodic event of the at least one identified episodic event is associated with at least one of a time, a location, or a description.

17. A method of displaying contents in an electronic device, the method comprising:
acquiring a voice input;
identifying an episodic event from the voice input;
acquiring at least one episodic element related to the episodic event from the voice input;
retrieving at least one content corresponding to the at least one acquired episodic element from a storage; and
displaying a visual object indicating the retrieved at least one content.

18. The method of claim 17, wherein the retrieved at least one content comprises at least one of an image, a document, an e-mail, an audio, or a video.

19. The method of claim 17, wherein the acquiring of the voice input comprises receiving the voice input from at least one of a microphone or a communication module.

20. The method of claim 17, further comprising:
outputting a voice for requesting a re-retrieval;
receiving an additional voice input as a response to the output voice; and
acquiring at least one additional episodic element from the additional voice input.

21. The method of claim 17, wherein the at least one episodic element is related to a time, a place, an emotion, or a name.
